(19) United States
(12) Patent Application Publication
(10) Pub. No.: US 2017/0341860 A1
(43) Pub. Date: Nov. 30, 2017

(54) CONTAINER ASSEMBLY FOR REFUSE VEHICLE

(71) Applicant: Oshkosh Corporation, Oshkosh, WI (US)

(72) Inventors: Bryan Dodds, Oshkosh, WI (US); Gary Largo, Oshkosh, WI (US)

(73) Assignee: Oshkosh Corporation, Oshkosh, WI (US)

(21) Appl. No.: 15/167,857

(22) Filed: May 27, 2016

(51) Int. Cl. B65F 1/12; B60P 1/50; B60P 7/04; B65G 67/04

(52) U.S. Cl. CPC B65F 1/122; B65G 67/04; B60P 1/50; B60P 7/04

(57) ABSTRACT

A container assembly includes a container, a collection arm assembly, a locking mechanism, and a controller. The container has a front wall, a rear wall, a first sidewall, and a second sidewall cooperatively defining an internal cavity. The collection arm assembly is slidably coupled to the container such that the collection arm assembly is selectively extendable laterally outward from the container. The collection arm assembly includes a retaining pocket. The locking mechanism includes a latch and an actuator. The latch is positioned to selectively engage with the retaining pocket of the collection arm assembly. The actuator is positioned to selectively reconfigure the latch between an unlocked position and a locked position. The controller is configured to engage the actuator to selectively reconfigure the latch into the locked position and thereby prevent the collection arm assembly from extending laterally outward from the container.

### BACKGROUND

Refuse vehicles collect a wide variety of waste, trash, and other material from residences and businesses. Operators of the refuse vehicle transport the material from various waste receptacles within a municipality to a storage or processing facility (e.g., a landfill, an incineration facility, a recycling facility, etc.).

### SUMMARY

One embodiment relates to a container assembly. The container assembly includes a container, a collection arm assembly, a locking mechanism, and a controller coupled to the locking mechanism. The container has a front wall, a rear wall, a first sidewall, and a second sidewall cooperatively defining an internal cavity. The collection arm assembly is slidably coupled to the container such that the collection arm assembly is selectively extendable laterally outward from the container to facilitate engaging a refuse bin to deposit refuse into the internal cavity of the container. The collection arm assembly includes a retaining pocket. The locking mechanism includes a latch and an actuator. The latch is positioned to selectively engage with the retaining pocket of the collection arm assembly. The actuator is positioned to selectively reconfigure the latch between an unlocked position and a locked position. The controller is configured to engage the actuator to selectively reconfigure the latch into the locked position and thereby prevent the collection arm assembly from extending laterally outward from the container.

Another embodiment relates to a container assembly. The container assembly includes a container and a cover assembly. The container has a front wall, a rear wall, a first sidewall, and a second sidewall cooperatively defining an internal cavity. The cover assembly is positioned to selectively enclose the internal cavity of the container. The cover assembly includes a cover, an arm, and an actuator. The cover has a pivot end, a free end, a first side, and a second side. The pivot end is pivotally coupled to at least one of the front wall, the rear wall, the first sidewall, and the second sidewall of the container. The arm is coupled to the cover in a location that is spaced from the pivot end. The actuator is positioned to selectively rotate the arm to open and close the cover.

Still another embodiment relates to a refuse vehicle. The refuse vehicle includes a chassis, a cab positioned at a front end of the chassis, and a container assembly. The container assembly includes a container and a collection arm assembly. The container has a front wall, a rear wall positioned between the front wall and the cab, a first sidewall, and a second sidewall cooperatively defining an internal cavity. The rear wall includes frame members extending at least one of vertically, horizontally, and diagonally along an interior surface of the rear wall. The collection arm assembly is slidably coupled to the rear wall of the container such that the collection arm assembly is selectively extendable laterally outward from the container to facilitate engaging a refuse bin to deposit refuse into the internal cavity of the container.

The invention is capable of other embodiments and of being carried out in various ways. Alternative exemplary embodiments relate to other features and combinations of features as may be recited in the claims.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a front perspective view of a container, according to an exemplary embodiment;

FIG. 3 is a front perspective view of a container assembly, according to an exemplary embodiment;

FIG. 4 is a rear perspective view of the container assembly of FIG. 3, according to an exemplary embodiment;

FIG. 5 is a detailed view of a locking mechanism of the container assembly of FIG. 3 selectively reconfigured in an unlocked configuration, according to an exemplary embodiment;

FIG. 6 is a detailed view of the locking mechanism of FIG. 5 selectively reconfigured in a locked configuration, according to an exemplary embodiment;

FIG. 7 is a perspective view of a cover assembly of a container assembly arranged in a closed configuration, according to an exemplary embodiment;

FIG. 8 is a perspective view of the cover assembly of FIG. 7 arranged in an open configuration, according to an exemplary embodiment;

FIG. 9 is a perspective view of a cover actuation system of the cover assembly of FIG. 7, according to an exemplary embodiment;

FIG. 10 is a schematic block diagram of a control system of the refuse vehicle of FIG. 1, according to an exemplary embodiment; and

FIG. 11 is a schematic diagram of a control strategy for engaging a locking mechanism of a container assembly, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

According to an exemplary embodiment, a container assembly for a front-loading refuse vehicle includes an active locking mechanism. The active locking mechanism may be configured to selectively limit the movement of a refuse collection arm assembly of the container assembly. According to an exemplary embodiment, the active locking mechanism is configured to automatically engage to prevent lateral movement of the refuse collection arm assembly as the container assembly is lifted (e.g., beyond a tilt angle threshold, etc.) by a lift system of the refuse vehicle. Traditional container assemblies may include passive locking mechanisms (e.g., gravity hinges, etc.). The active locking mechanism may advantageously provide (i) increased selectability, (ii) increased stability, (iii) an immediate locking action, and/or (iv) improved operation in harsh conditions relative to passive locking mechanisms. The container assembly may additionally include reinforcement members positioned along a rear wall of a container of the container assembly to provide increased support during operation of the refuse collection arm assembly that may be slidably attached thereto. The container assembly may also include a cover that is selectively opened and closed. Traditional covers include lightweight, flexible, and/or mesh flaps. The cover of the present disclosure may be manufactured from a more durable, rigid, and/or heavier duty material configured to (i) maintain the shape of the cover as the cover is opened and closed, (ii) provide increased performance in windy conditions, and/or (iii) better maintain refuse within an internal cavity of the container as the refuse vehicle encounters obstacles (e.g., speed bumps, curbs, pot holes, etc.).

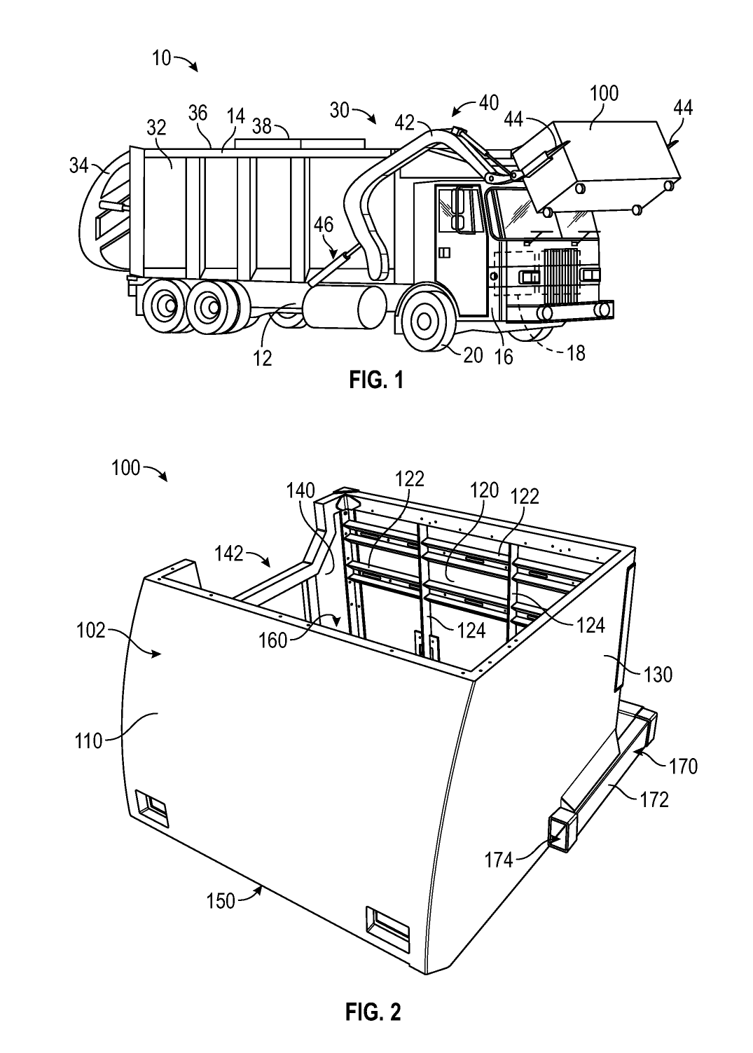

According to the exemplary embodiment shown in FIGS. 1-9, a vehicle, shown as refuse vehicle 10 (e.g., garbage truck, waste collection truck, sanitation truck, etc.), is configured as a front-loading refuse truck having a front-loading refuse container assembly, shown as container assembly 100. As shown in FIG. 1, the refuse vehicle 10 includes a chassis, shown as frame 12, a body assembly, shown as body 14, coupled to the frame 12 (e.g., a rear end thereof, etc.), and a cab, shown as cab 16, coupled to the frame 12 (e.g., a front end thereof, etc.). The cab 16 may include various components to facilitate operation of the refuse vehicle 10 by an operator (e.g., a seat, a steering wheel, hydraulic controls, a user interface, switches, buttons, dials, etc.). As shown in FIG. 1, the refuse vehicle 10 includes a prime mover, shown as engine 18, coupled to the frame 12 at a position beneath the cab 16. The engine 18 is configured to provide power to a plurality of tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from an on-board storage device (e.g., batteries, ultra-capacitors, etc.), from an on-board generator (e.g., an internal combustion engine, etc.), and/or from an external power source (e.g., overhead power lines, etc.) and provide power to the systems of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may be thereafter compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (i.e., refuse is loaded into a position of the refuse compartment 30 behind the cab 16 and stored in a position further toward the rear of the refuse compartment 30).

As shown in FIG. 1, the refuse vehicle 10 includes a lift system, shown as lift assembly 40. The lift assembly 40 includes a pair of arms, shown as lift arms 42, coupled to frame 12 on either side of the refuse vehicle 10. The lift arms 42 may be rotatably coupled to frame 12 with a pivot (e.g., a lug, a shaft, etc.). As shown in FIG. 1, the lift assembly 40 includes an actuator system, shown as lift arm actuators 46 (e.g., hydraulic cylinders, etc.), coupled to the frame 12 and the lift arms 42. The lift arm actuators 46 are positioned such that extension and retraction thereof rotates the lift arms 42 about an axis extending through the pivot, according to an exemplary embodiment. As shown in FIG. 1, the lift assembly 40 includes interface members, shown as forks 44, coupled to the lift arms 42. The forks 44 may have a generally rectangular cross-sectional shape and may engage the container assembly 100 (e.g., protrude through fork pockets of the container assembly 100, etc.). During operation of the refuse vehicle 10, the forks 44 may be positioned to engage the container assembly 100 (e.g., the refuse vehicle 10 is driven into position such that the forks 44 protrude through fork pockets of the container assembly 100, etc.). As shown in FIG. 1, the lift arms 42 are rotated by the lift arm actuators 46 to lift the container assembly 100 over the cab 16. A second actuator (e.g., a hydraulic cylinder, etc.) may articulate the forks 44 to tip refuse out of the container assembly 100 and into the hopper volume of the refuse compartment 30 through an opening in the cover 36. The lift arm actuators 46 may thereafter rotate the lift arms 42 to return the empty container assembly 100 to the ground. According to an exemplary embodiment, a door, shown as top door 38 is movably positioned along the cover 36 to seal the opening thereby preventing refuse from escaping the refuse compartment 30 (e.g., due to wind, bumps in the road, etc.).

As shown in FIGS. 2-9, the container assembly 100 includes: a container, shown as refuse container 102; a refuse collection arm assembly, shown as collection arm assembly 200; a collection arm locking mechanism, shown as locking mechanism 300; and a container cover assembly, shown as cover assembly 400. As shown in FIGS. 2-4 and 7-9, the refuse container 102 has a first wall, shown as front wall 110, an opposing second wall, shown as rear wall 120 (e.g., positioned between the cab 16 and the front wall 110, etc.), a first sidewall, shown as first sidewall 130, an opposing second sidewall, shown as second sidewall 140, and a bottom surface, shown as bottom 150. The front wall 110, the rear wall 120, the first sidewall 130, the second sidewall 140, and the bottom 150 cooperatively define an internal cavity, shown as container refuse compartment 160. According to an exemplary embodiment, the container refuse compartment 160 is configured to receive refuse from the collection arm assembly 200.

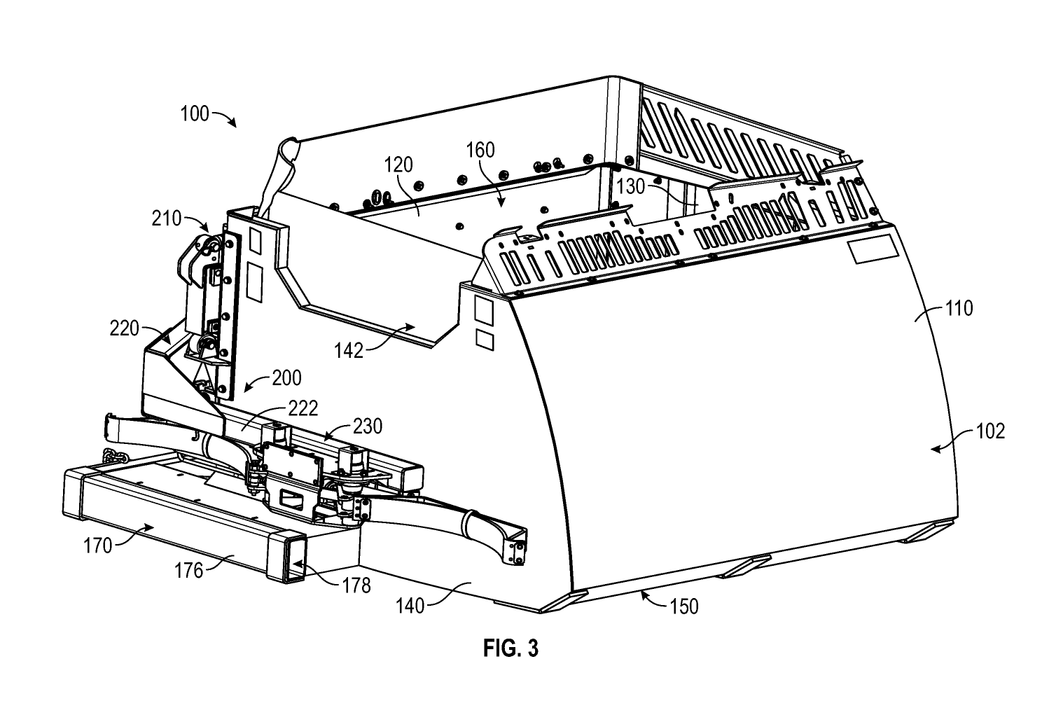

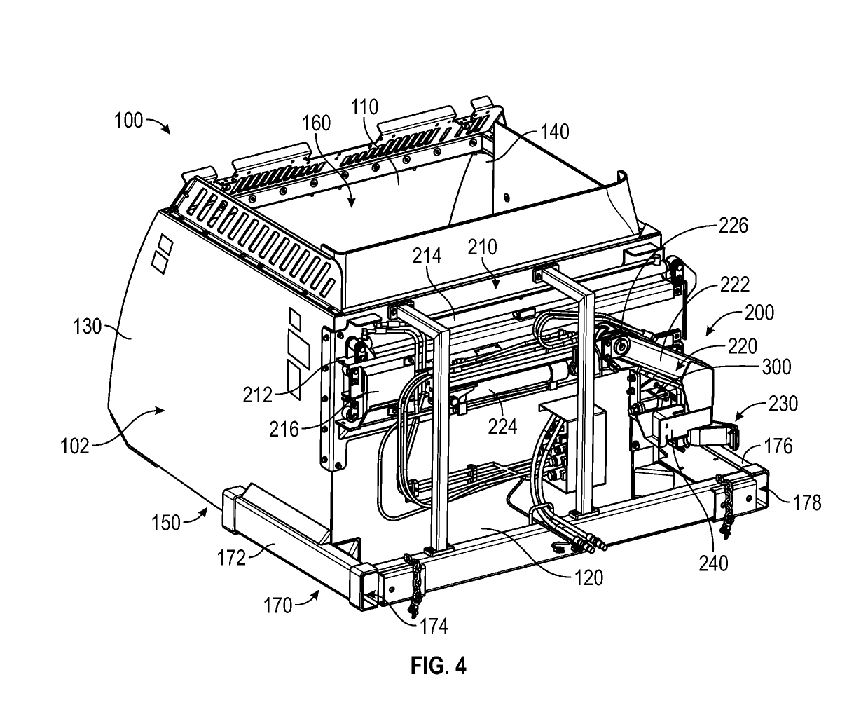

As shown in FIGS. 2-4, the refuse container 102 includes an interface, shown as fork interface 170. As shown in FIGS. 2 and 4, the fork interface 170 includes a first interface portion, shown as first fork interface 172, positioned along the first sidewall 130. The first fork interface 172 defines a first pocket, shown as first fork pocket 174. As shown in FIGS. 3-4, the fork interface 170 includes a second interface portion, shown as second fork interface 176, positioned along the second sidewall 140. The second fork interface 176 defines a second pocket, shown as second fork pocket 178. According to an exemplary embodiment, the first fork pocket 174 and the second fork pocket 178 are configured to receive the forks 44 of the refuse vehicle 10. The lift assembly 40 may thereby be configured to lift the container assembly 100 to empty the refuse within the container refuse compartment 160 of the refuse container 102 into the refuse compartment 30 of the refuse vehicle 10.

As shown in FIGS. 3-4, the collection arm assembly 200 is coupled to the rear wall 120 of the refuse container 102. As shown in FIGS. 3-4, the collection arm assembly 200 includes a first portion, shown as translatable portion 210, a second portion, shown as rotatable portion 220, and a third portion, shown as grabber assembly 230. As shown in FIG. 4, the translatable portion 210 of the collection arm assembly 200 includes a carriage assembly, shown as slide track 212, a first actuator (e.g., pneumatic actuator, hydraulic actuator, electric actuator, etc.), shown as translation actuator 214, and a slideable member, shown as slide assembly 216. As shown in FIG. 4, the slide track 212 is coupled (e.g., fastened, welded, etc.) to the rear wall 120 of the refuse container 102. According to an exemplary embodiment, the slide assembly 216 is slidably coupled to the slide track 212. The translation actuator 214 is positioned to facilitate selectively extending and retracting the slide assembly 216 within the slide track 212 such that the grabber assembly 230 of the collection arm assembly 200 may extend laterally outward from and retract laterally inward toward the refuse container 102, according to an exemplary embodiment.

As shown in FIG. 4, the rotatable portion 220 of the collection arm assembly 200 includes an arm, shown as rotatable arm 222, and a second actuator (e.g., pneumatic actuator, hydraulic actuator, electric actuator, etc.), shown as lift actuator 224. As shown in FIG. 4, the rotatable arm 222 is pivotally coupled to the slide assembly 216 and rotates about a joint, shown as pivot 226. As shown in FIGS. 3-4, the grabber assembly 230 is coupled to an end of the rotatable arm 222 (e.g., opposite the pivot 226, etc.). According to an exemplary embodiment, the grabber assembly 230 is configured to selectively open and close to engage and release a refuse bin. The lift actuator 224 is positioned to facilitate selectively pivoting the rotatable arm 222 and the grabber assembly 230 about the pivot 226, according to an exemplary embodiment. The collection arm assembly 200 may thereby facilitate engaging a refuse bin (e.g., positioned at a curb of a driveway, etc.) to deposit refuse from the refuse bin into the container refuse compartment 160 of the refuse container 102. As shown in FIGS. 2-3, the second sidewall 140 defines a cutout, shown as refuse bin cutout 142. The refuse bin cutout 142 may be positioned to provide an edge or space for refuse bins to engage or pass into as the collection arm assembly 200 tips a respective refuse bin to empty the contents (e.g., refuse, waste, trash, recyclable materials, etc.) therein into the container refuse compartment 160 of the refuse container 102. As shown in FIG. 4, the collection arm assembly 200 includes a locking interface, shown as retaining pocket 240. According to an exemplary embodiment, the locking mechanism 300 is configured to engage with the retaining pocket 240 to selectively lock the collection arm assembly 200 in a stowed position (e.g., as shown in FIG. 4, etc.) to prevent the collection arm assembly 200 from inadvertently extending laterally outward from the refuse container 102 (e.g., as the container assembly 100 is lifted by the lift assembly 40 of the refuse vehicle 10, etc.).

As shown in FIGS. 2 and 8-9, the rear wall 120 of the refuse container 102 includes frame members, shown as first reinforcement members 122 and second reinforcement members 124, extending vertically and horizontally along an interior surface of the rear wall 120, respectively. In some embodiments, the rear wall 120 does not include the first reinforcement members 122. In other embodiments, the rear wall 120 does not include the second reinforcement members 124. In some embodiments, the rear wall 120 additionally or alternatively includes third reinforcement members extending diagonally along the rear wall 120. According to an exemplary embodiment, the first reinforcement members 122, the second reinforcement members 124, and/or the third reinforcement members are positioned to reinforce the rear wall 120 to provide increased support for the increased loading experienced by the rear wall 120 during operation of the collection arm assembly 200.

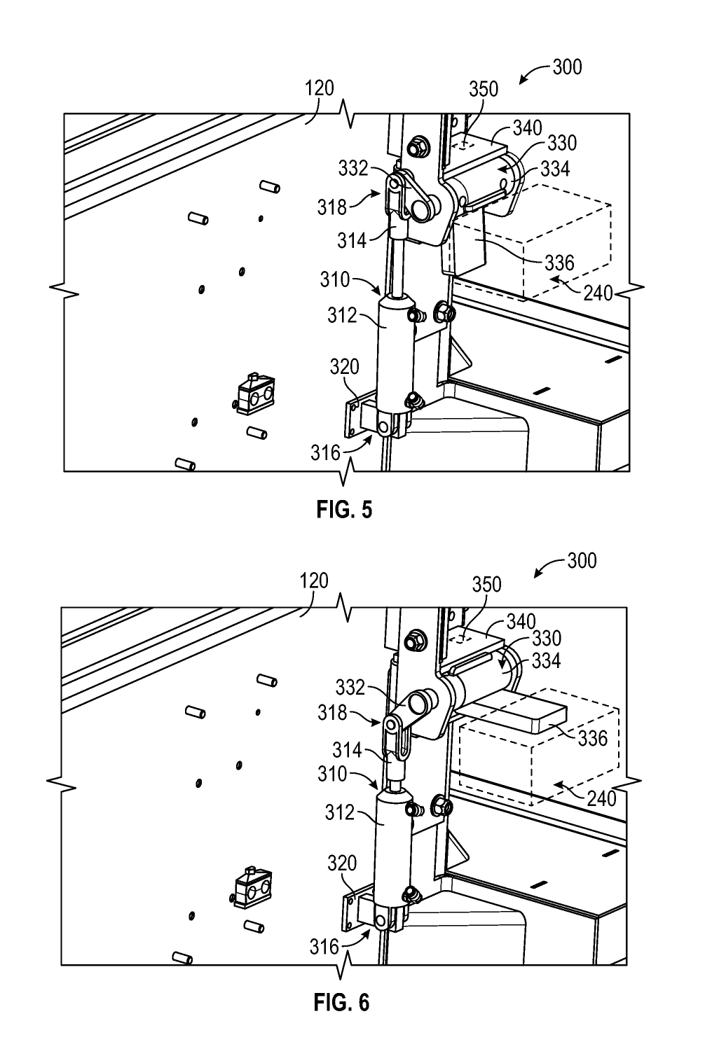

As shown in FIGS. 5-6, the locking mechanism 300 includes an actuator, shown as locking actuator 310, and a latch, shown as locking latch 330. According to an exemplary embodiment, the locking actuator 310 includes a pneumatic actuator (e.g., having a pneumatic cylinder, a controllable valve, a high pressure air source, etc.). In other embodiments, the locking actuator 310 includes a hydraulic actuator (e.g., a hydraulic cylinder, a hydraulic fluid reservoir, a controllable valve, etc.). In still other embodiments, the locking actuator 310 includes an electric actuator (e.g., a solenoid, an electric motor, an electric power source, etc.). As shown in FIGS. 5-6, the locking actuator 310 includes a cylinder, shown as cylinder 312, and a rod, shown as rod 314. According to an exemplary embodiment, the rod 314 extends from and retracts within the cylinder 312. As shown in FIGS. 5-6, the locking actuator 310 includes a first end, shown as cylinder end 316, and an opposing second end, shown as rod end 318. As shown in FIGS. 5-6, the locking latch 330 includes a coupling member, shown as coupler 332, a main body, shown as body 334, and an extension member, shown as extender 336, that projects from the body 334.

As shown in FIGS. 5-6, the locking mechanism 300 includes a first bracket, shown as actuator bracket 320, and a second bracket, shown as latch bracket 340. The actuator bracket 320 is positioned to couple the cylinder end 316 of the locking actuator 310 to the rear wall 120 of the refuse container 102. The latch bracket 340 is positioned to rotatably couple the locking latch 330 to the rear wall 120 of the refuse container 102. The rod end 318 of the locking actuator 310 is positioned to couple to the coupler 332 of the locking latch 330. As shown in FIGS. 5-6, the locking latch 330 is positioned such that the extender 336 selectively interfaces with the retaining pocket 240 of the collection arm assembly 200. The locking actuator 310 is positioned to facilitate actuating the locking latch 330 between an unlocked position (e.g., as shown in FIG. 5, etc.) and a locked position (e.g., as shown in FIG. 6, etc.). According to an exemplary embodiment, the rod 314 extends and/or retracts to selectively rotate the locking latch 330 from the unlocked position to the locked position such that the extender 336 interfaces with the retaining pocket 240 to limit movement of the collection arm assembly 200 (e.g., prevent the collection arm assembly 200 from extending laterally outward from the refuse container 102, retain the collection arm assembly 200 in a stowed position, etc.).

As shown in FIGS. 5-6, the container assembly includes a sensor (e.g., an inclinometer, a gyroscope, an accelerometer, etc.), shown as tilt sensor 350. According to an exemplary embodiment, the tilt sensor 350 is positioned to acquire tilt data indicative of a tilt angle of the container assembly 100 relative to gravity, a nominal position (e.g., a non-lifted positioned, etc.), and/or a ground surface. According to the exemplary embodiment shown in FIGS. 5-6, the tilt sensor 350 is positioned on the latch bracket 340. In other embodiments, the tilt sensor 350 is positioned on the refuse container 102 (e.g., the front wall 110, the rear wall 120, the first sidewall 130, the second sidewall 140, etc.). In still other embodiments, the tilt sensor 350 is positioned on the collection arm assembly 200. In alternative embodiments, the tilt sensor 350 is positioned on the lift assembly 40 (e.g., the lift arms 42, the forks 44, etc.). In yet other alternative embodiments, the refuse vehicle 10 additionally or alternatively includes a displacement sensor positioned to acquire displacement data from the lift arm actuators 46 indicative of an amount of extension and/or retraction of the lift arm actuators 46. The displacement data may be used to determine an amount of rotation (e.g., an angle, etc.) of the lift assembly 40 (e.g., the lift arms 42, the forks 44, etc.) relative to a nominal position (e.g., a stowed position, a ground position, etc.). According to an exemplary embodiment, the locking mechanism 300 is configured to be actively engaged (e.g., locked, etc.) as the container assembly 100 is lifted beyond a target angle (e.g., 30 degrees, 45 degrees, 60 degrees, etc.) by the lift assembly 40 of the refuse vehicle 10 to empty refuse within the container refuse compartment 160 of the refuse container 102 into the refuse compartment 30 of the refuse vehicle 10.

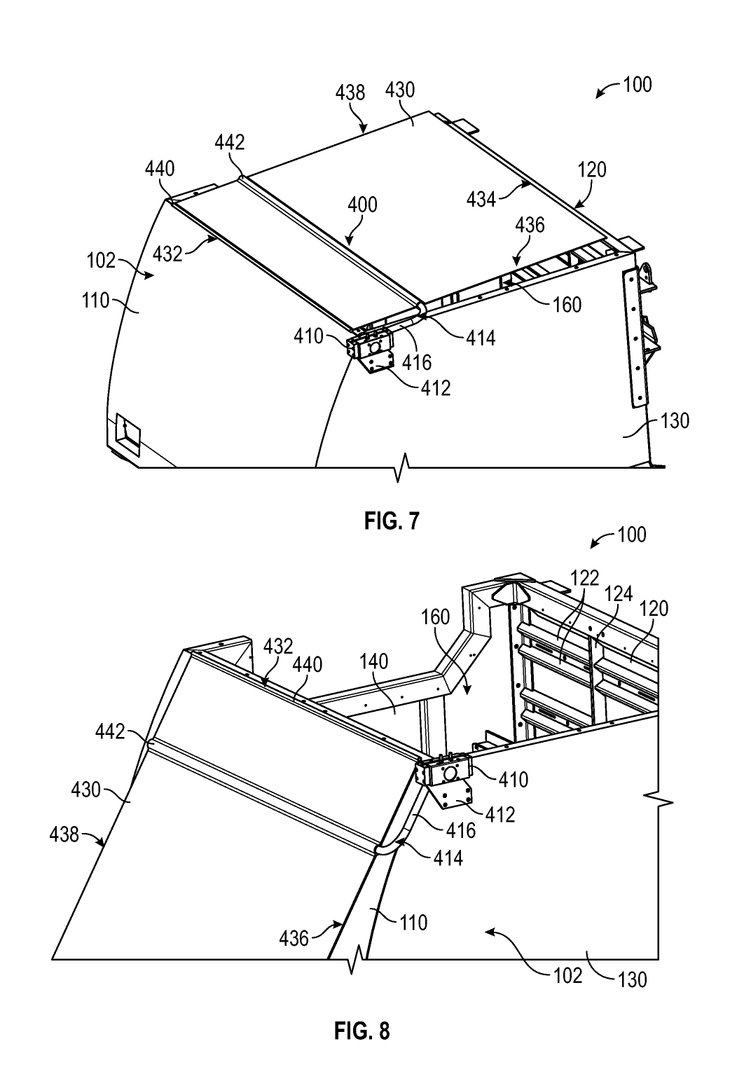

As shown in FIGS. 7-9, the cover assembly 400 includes an actuator, shown as cover actuator 410, an arm, shown as cover arm 414, and a cover, shown as cover 430. The cover 430 is positioned to selectively enclose the container refuse compartment 160 of the refuse container 102. As shown in FIGS. 7-8, the cover 430 has a first end, shown as pivot end 432, an opposing second end, shown as free end 434, a first side, shown as first side 436, and an opposing second side, shown as second side 438. According to the exemplary embodiment shown in FIGS. 7-8, the pivot end 432 is rotatably coupled to the front wall 110 of the refuse container 102 with a pivot element (e.g., a hinge, a rod, etc.), shown as pivot 440, such that the free end 434 rotates about the pivot 440 (e.g., positioned along the front wall 110, etc.). In other embodiments, the pivot end 432 is rotatably coupled to the rear wall 120 (e.g., such that the free end 434 rotates about the pivot 440 positioned along the rear wall 120, etc.), the first sidewall 130 (e.g., such that the free end 434 rotates about the pivot 440 positioned along the first sidewall 130, etc.), and/or the second sidewall 140 (e.g., such that the free end 434 rotates about the pivot 440 positioned along the second sidewall 140, etc.).

As shown in FIGS. 7-8, the cover 430 includes an interface (e.g., a slot, etc.), shown as arm pocket 442. The arm pocket 442 is positioned between the pivot end 432 and the free end 434 of the cover 430 (e.g., at a location that is spaced from the pivot end 432, etc.). According to the exemplary embodiment shown in FIGS. 7-8, the arm pocket 442 extends laterally from the first side 436 to the second side 438. In other embodiments, the arm pocket 442 extends laterally between the first side 436 and the second side 438 (e.g., halfway, three-quarters, etc.).

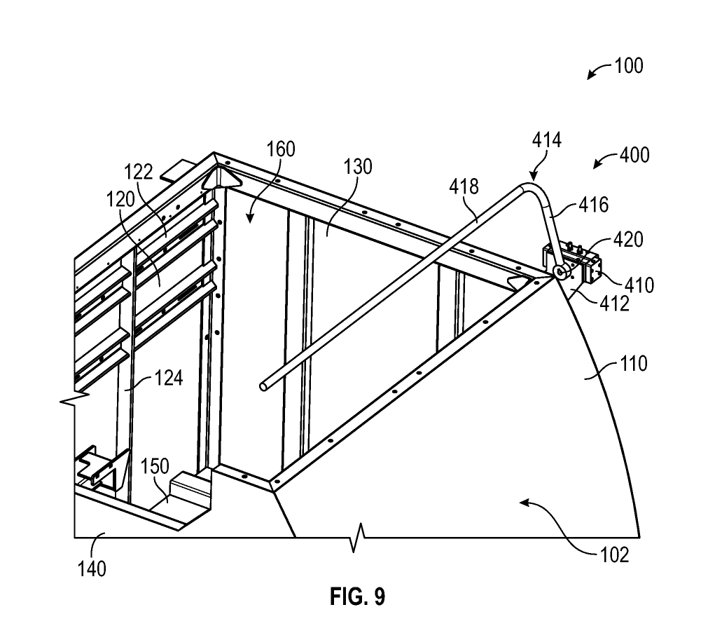

As shown in FIGS. 7-9, the cover arm 414 includes a first portion, shown as radial arm portion 416, and as second portion, shown as extension arm portion 418. As shown in FIG. 9, the radial arm portion 416 is coupled to the cover actuator 410 at a rational joint, shown as pivot 420. As shown in FIGS. 7-9, the radial arm portion 416 spaces the extension arm portion 418 from the pivot 420 such that the extension arm portion 418 aligns with and is received by the arm pocket 442 of the cover 430. In other embodiments, the cover 430 does not include the arm pocket 442. In such embodiments, the cover arm 414 may directly couple to the body of the cover 430, the free end 434, the first side 436, and/or the second side 438. According to an exemplary embodiment, the cover actuator 410 is positioned to selectively rotate the cover arm 414 about the pivot 420 such that the cover arm 414 rotates the cover 430 about the pivot 440 of the pivot end 432 to open and close the cover 430. The extension arm portion 418 may freely rotate within the arm pocket 442 (e.g., slip, etc.) during such opening and closing operation, according to an exemplary embodiment.

As shown in FIGS. 7-9, the cover actuator 410 is coupled to the first sidewall 130 with a bracket, shown as actuator bracket 412. In other embodiments, the actuator bracket 412 is positioned to couple the cover actuator 410 to the second sidewall 140. In some embodiments, the cover assembly 400 includes a pair of cover actuators 410 and actuator brackets 412, one positioned on each of the first sidewall 130 and the second sidewall 140. In still other embodiments, the actuator bracket 412 is positioned to couple the cover actuator 410 to the front wall 110 and/or the rear wall 120. In some embodiments, the cover assembly 400 includes a pair of cover actuators 410 and actuator brackets 412, one positioned on each of the front wall 110 and the rear wall 120. In alternative embodiments, the cover 430 includes a plurality of pieces or portions (e.g., a first portion that is coupled to the front wall 110 and a second portion that is coupled to the rear wall 120 that open in opposite directions, etc.). In still other alternative embodiments, the cover 430 is selectively extendable across the container refuse compartment 160 (e.g., a retractable and/or roll-able cover, etc.). According to an exemplary embodiment, the cover actuator 410 includes an electric actuator (e.g., a motor, etc.).

According to an exemplary embodiment, the cover 430 is manufactured from a durable, rigid, and/or heavy duty material. Traditional covers may be manufactured from a lightweight mesh. The durable, rigid, and/or heavy duty material of the cover 430 is configured to (i) maintain its shape as the cover 430 is opened and closed, (ii) provide increased performance in windy conditions, and/or (iii) better maintain refuse within the container refuse compartment 160 as the refuse vehicle 10 experiences bumpy road conditions relative to traditional covers. In some embodiments, the cover 430 includes a rod (e.g., a fiberglass rod, a metal rod, a plastic rod, etc.) positioned along at least one of the first side 436 and the second side 438 to increase the stiffness of the cover 430.

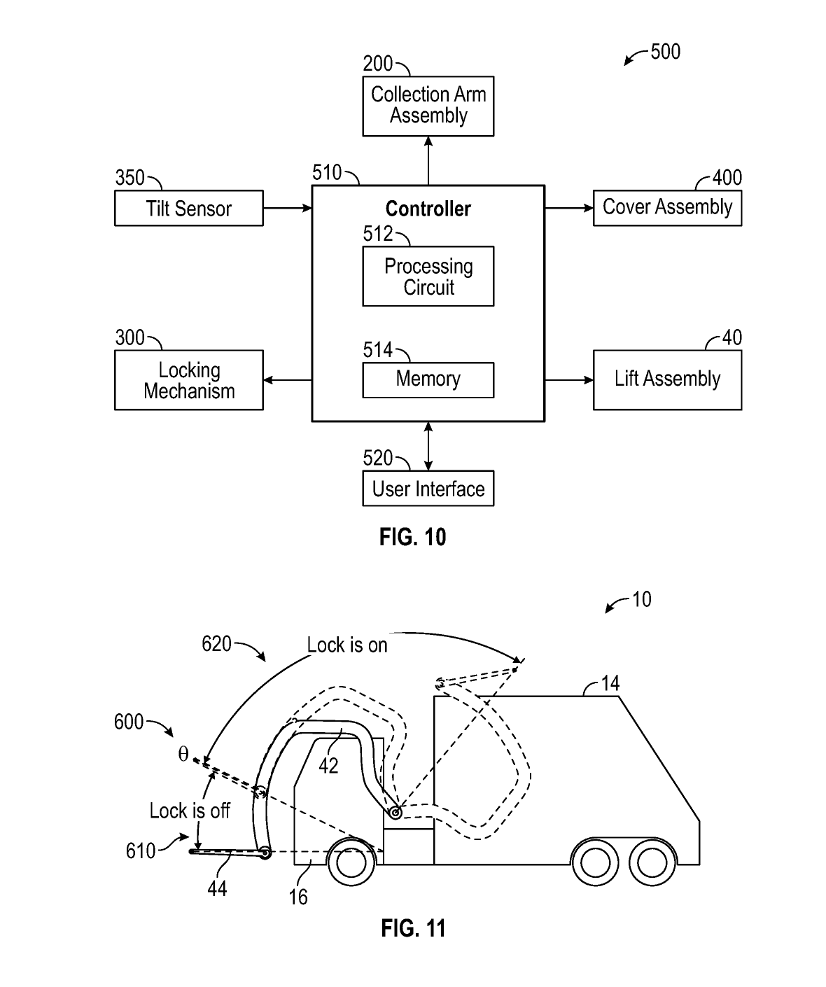

According to the exemplary embodiment shown in FIG. 10, a control system 500 for the refuse vehicle 10 includes a controller 510. In one embodiment, the controller 510 is configured to selectively engage, selectively disengage, control, and/or otherwise communicate with components of the refuse vehicle 10 (e.g., actively control the components thereof, etc.). As shown in FIG. 10, the controller 510 is coupled to the lift assembly 40 (e.g., the lift arm actuators 46, etc.), the collection arm assembly 200 (e.g., the translation actuator 214, the lift actuator 224, the grabber assembly 230, etc.), the locking mechanism 300 (e.g., the locking actuator 310, etc.), the tilt sensor 350, the cover assembly 400 (e.g., the cover actuator 410, etc.), and a user interface 520. In other embodiments, the controller 510 is coupled to more or fewer components. The controller 510 may be configured to actively control the locking mechanism 300 of the container assembly 100 to prevent the collection arm assembly 200 from laterally translating outward as the container assembly 100 is lifted by the lift assembly 40. By way of example, the controller 510 may actively engage the locking mechanism 300 when the container assembly 100 is oriented at and/or exceeds a target or threshold angle (e.g., 20 degrees, 30 degrees, 45 degrees, etc.) relative to gravity, a nominal position, and/or a ground surface. By way of example, the controller 510 may send and/or receive signals with the lift assembly 40, the collection arm assembly 200, the locking mechanism 300, the tilt sensor 350, the cover assembly 400, and/or the user interface 520.

The controller 510 may be implemented as a general-purpose processor, an application specific integrated circuit (ASIC), one or more field programmable gate arrays (FPGAs), a digital-signal-processor (DSP), circuits containing one or more processing components, circuitry for supporting a microprocessor, a group of processing components, or other suitable electronic processing components. According to the exemplary embodiment shown in FIG. 10, the controller 510 includes a processing circuit 512 and a memory 514. The processing circuit 512 may include an ASIC, one or more FPGAs, a DSP, circuits containing one or more processing components, circuitry for supporting a microprocessor, a group of processing components, or other suitable electronic processing components. In some embodiments, the processing circuit 512 is configured to execute computer code stored in the memory 514 to facilitate the activities described herein. The memory 514 may be any volatile or non-volatile computer-readable storage medium capable of storing data or computer code relating to the activities described herein. According to an exemplary embodiment, the memory 514 includes computer code modules (e.g., executable code, object code, source code, script code, machine code, etc.) configured for execution by the processing circuit 512. In some embodiments, controller 510 represents a collection of processing devices (e.g., servers, data centers, etc.). In such cases, the processing circuit 512 represents the collective processors of the devices, and the memory 514 represents the collective storage devices of the devices.

In one embodiment, the user interface 520 includes a display and an operator input. The display may be configured to display a graphical user interface, an image, an icon, and/or still other information. In one embodiment, the display includes a graphical user interface configured to provide general information about the refuse vehicle 10 (e.g., vehicle speed, fuel level, warning lights, etc.). The graphical user interface may also be configured to display a current position of the container assembly 100 (e.g., angle relative to a ground surface, etc.), a current position of the grabber assembly 230, and/or current position of the cover assembly 400 (e.g., the cover 430, etc.).

The operator input may be used by an operator to provide commands to at least one of the lift assembly 40, the collection arm assembly 200, the locking mechanism 300, the tilt sensor 350, and the cover assembly 400. The operator input may include one or more buttons, knobs, touchscreens, switches, levers, joysticks, pedals, a steering wheel, or handles. The operator input may facilitate manual control of some or all aspects of the operation of the lift assembly 40, the collection arm assembly 200, the locking mechanism 300, the tilt sensor 350 (e.g., setting the target/threshold angle, etc.), and/or the cover assembly 400. It should be understood that any type of display or input controls may be implemented with the systems and methods described herein.

By way of example, an operator may manually provide a command to the controller 510 using the user interface 520 to selectively engage, selectively disengage, and/or otherwise control the lift assembly 40, the collection arm assembly 200, the locking mechanism 300, and/or the cover assembly 400. For example, an operator may control the extension and/or retraction of the translation actuator 214, the lift actuator 224, and/or the grabber assembly 230 to engage refuse receptacles (e.g., on the side of the street, garbage cans, etc.) to empty refuse within the refuse receptacles into the container refuse compartment 160 of the refuse container 102 using the user interface 520. In another example, an operator may control the extension and/or retraction of the lift arm actuators 46 to lift the container assembly 100 over the cab 16 to empty refuse out of the container assembly 100 and into the refuse compartment 30 of the refuse vehicle 10 using the user interface 520. In yet another example, an operator may selectively control the cover actuator 410 to open and/or close the cover 430 to allow the ingress and/or egress of refuse into and/or from the refuse container 102 using the user interface 520. In still another example, an operator may selectively engage and/or disengage the locking latch 330 of the locking mechanism 300 to lock and/or unlock the collection arm assembly 200 in the stowed position using the user interface 520.

According to an exemplary embodiment, the controller 510 is configured to send and/or receive tilt data from the tilt sensor 350. The tilt sensor 350 may be positioned to acquire the tilt data regarding the tilt angle of the container assembly 100 relative to gravity, a nominal position (e.g., a non-lifted positioned, etc.), and/or a ground surface. The tilt data may be indicative of an angle of the container assembly 100 relative to gravity, a nominal position, and/or a ground surface. According to an exemplary embodiment, the controller 510 is configured to monitor the position of the container assembly 100 based on the tilt data. In an alternative embodiment, the controller 510 monitors the position of the container assembly 100 based on displacement data received from displacement sensors of the lift arm actuators 46.

The controller 510 may be configured to control operation of the locking actuator 310 to selectively actuate the locking latch 330 into the locked position to interface with the retaining pocket 240 of the collection arm assembly 200 to prevent the collection arm assembly 200 from extending laterally outward from the refuse container 102. According to an exemplary embodiment, the controller 510 is configured to control operation of the locking actuator 310 to selectively reconfigure the locking latch 330 into the locked position in response to the tilt angle of the container assembly 100 exceeding a threshold tilt angle. As shown in FIG. 11, the lift arms 42 may lift the forks 44 of the refuse vehicle 10 through a range of motion to lift the container assembly 100 over the cab 16 to empty refuse out of the container assembly 100 into the refuse compartment 30 of the body 14 of the refuse vehicle 10. The range of motion at which the forks 44 and/or the container assembly 100 travel may be monitored by the controller 510 with the tilt sensor 350. As shown in FIG. 11, the range of motion is separated into a first portion, shown as unlocked portion 610, and a second portion shown as locked portion 620. According to an exemplary embodiment, the controller 510 is configured to selectively disengage the locking mechanism 300 during the unlocked portion 610 and selectively engage the locking mechanism 300 during the locked portion 620. As shown in FIG. 11, the transition between the unlocked portion 610 and the locked portion 620 occurs at an angle, shown as threshold tilt angle 600. The threshold tilt angle 600 may define an angle at which the controller 510 is configured to actuate the locking actuator 310 to engage the locking latch 330 with the retaining pocket 240 of the collection arm assembly 200. According to an exemplary embodiment, the threshold tilt angle 600 is at least 30 degrees (e.g., relative to a nominal position of the container assembly 100, to gravity, to a ground surface, etc.). In one embodiment, the threshold tilt angle 600 is between 35 and 55 degrees (e.g., relative to a nominal position of the container assembly 100, to gravity, to a ground surface, etc.). In some embodiments, the threshold tilt angle 600 is approximately 45 degrees. In alternative embodiments, the threshold tilt angle 600 is less than 30 degrees or greater than 55 degrees.

According to an exemplary embodiment, the active locking mechanism 300 provides various advantages over passive locking mechanisms such as gravity hinges of traditional container assemblies. Gravity hinges may operate by rotating as the force of gravity on the hinge changes as the respective container assembly is lifted by a refuse vehicle. The locking mechanism 300 of the present disclosure is actively controlled such that the locking mechanism 300 provides increased selectability, increased stability, an immediate locking action, and/or improved operation in harsh conditions relative to gravity hinges. By way of example, the locking mechanism 300 may provide increased selectability as the threshold tilt angle 600 may be selectively adjusted to any desired angle (e.g., independent of the physical and mechanical characteristics of the locking latch 330 itself, etc.), while gravity hinges operate passively and depend on gravity. By way of another example, the locking mechanism 300 may provide increased stability as the locking mechanism 300 may be manually engaged by an operator of the refuse vehicle 10 (e.g., when the refuse vehicle is traveling through tight spaces, at high speeds, etc.). By way of yet another example, the locking mechanism 300 may provide an immediate locking action rather than a gradual locking action of a gravity hinge. By way if still another example, the locking mechanism 300 may provide improved operation in harsh conditions as the retaining pocket 240 may become filled and/or blocked with dirt, debris, mud, snow, etc. during operation of the refuse vehicle 10 and/or the container assembly 100. Such blocking of the retaining pocket 240 may render a gravity hinge inoperable. Advantageously, the locking mechanism 300 is an active system that is capable of forcing the locking latch 330 into engagement with the retaining pocket 240, thereby maintaining operability and the locking function (e.g., even if the retaining pocket 240 is filled with debris, etc.). Further, gravity hinges may become frozen during snow storms and/or ice storms, again rendering the gravity hinge inoperable.

The controller 510 may be configured to filter out rapid changes in the tilt data received from the tilt sensor 350 using a bump delay. By way of example, the tilt angle of the container assembly 100 may change rapidly as the refuse vehicle 10 encounters various obstacles (e.g., speed bumps, pot holes, curbs, etc.) while driving such that the tilt sensor 350 acquires tilt data indicating that the container assembly 100 exceeds the threshold tilt angle 600 (e.g., for a short period of time, without a command being sent to the lift arm actuators 46 to lift the container assembly 100, etc.). The controller 510 may be configured to identify such occurrences and prevent inadvertent locking of the locking mechanism 300.

The controller 510 may be configured to control operation of the cover actuator 410 to selectively actuate the cover 430 between the open position and the closed position. In some embodiments, the controller 510 is configured to control operation of the cover actuator 410 based on tilt angle of the container assembly 100. By way of example, the controller 510 may be configured to open the cover 430 with the cover actuator 410 in response to the container assembly 100 being lifted by the lift assembly 40 beyond an angle threshold (e.g., the threshold tilt angle 600, 80 degrees, 90 degrees, 115 degrees, etc.). In some embodiments, the controller 510 is configured to control operation of the cover actuator 410 based on a position of the grabber assembly 230. By way of example, the controller 510 may be configured to open the cover 430 with the cover actuator 410 in response to the grabber assembly 230 passing a target position (e.g., approaching the refuse bin cutout 142, etc.), allowing the grabber assembly 230 to dump refuse from a refuse bin into the container refuse compartment 160 of the refuse container 102. In some embodiments, the controller 510 is configured to control operation of the cover actuator 410 based on a mode of operation of the refuse vehicle 10. By way of example, the controller 510 may be configured to close the cover 430 with the cover actuator 410 in response to refuse vehicle 10 being driven (e.g., above a speed threshold, etc.) and/or open the cover 430 with the cover actuator 410 in response to refuse vehicle 10 stopping (or being driven below the speed threshold).

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

1. A container assembly, comprising:
a container having a front wall, a rear wall, a first sidewall, and a second sidewall cooperatively defining an internal cavity;
a collection arm assembly slidably coupled to the container such that the collection arm assembly is selectively extendable laterally outward from the container to facilitate engaging a refuse bin to deposit refuse into the internal cavity of the container, the collection arm assembly including a retaining pocket;
a locking mechanism including:
a latch positioned to selectively engage with the retaining pocket of the collection arm assembly; and
an actuator positioned to selectively reconfigure the latch between an unlocked position and a locked position; and
a controller coupled to the locking mechanism, the controller configured to engage the actuator to selectively reconfigure the latch into the locked position and thereby prevent the collection arm assembly from extending laterally outward from the container.

2. The container assembly of claim 1, further comprising a tilt sensor positioned to acquire tilt data indicative of a tilt angle of the container assembly.

3. The container assembly of claim 2, wherein the controller is coupled to the tilt sensor.

4. The container assembly of claim 3, wherein the controller is configured to receive the tilt data from the tilt sensor and engage the actuator to selectively reconfigure the latch into the locked position in response to the tilt angle of the container assembly exceeding a threshold tilt angle.

5. The container assembly of claim 4, wherein the threshold tilt angle is at least 30 degrees.

6. The container assembly of claim 5, wherein the threshold tilt angle is between 35 and 55 degrees.

7. The container assembly of claim 4, wherein the controller includes a bump delay configured to filter out rapid changes in the tilt angle and thereby prevent inadvertent engagement of the locking mechanism.

8. The container assembly of claim 1, wherein the actuator includes a pneumatic actuator.

9. The container assembly of claim 1, wherein the actuator includes at least one of a hydraulic cylinder and an electric actuator.

10. The container assembly of claim 1, wherein the locking mechanism is coupled to the rear wall of the container.

11. A container assembly, comprising:
a container having a front wall, a rear wall, a first sidewall, and a second sidewall cooperatively defining an internal cavity; and
a cover assembly positioned to selectively enclose the internal cavity of the container, the cover assembly including:
a cover having a pivot end, a free end, a first side, and a second side, the pivot end pivotally coupled to at least one of the front wall, the rear wall, the first sidewall, and the second sidewall of the container;
an arm coupled to the cover in a location that is spaced from the pivot end; and
an actuator positioned to selectively rotate the arm to open and close the cover.

12. The container assembly of claim 11, wherein the cover includes a pocket extending laterally from the first side towards the second side and is positioned between the pivot end and the free end, and wherein the pocket is configured to receive a portion of the arm.

13. The container assembly of claim 11, wherein the cover includes a rod positioned along at least one of the first side and the second side.

14. The container assembly of claim 11, wherein the cover is manufactured from a rigid material.

15. The container assembly of claim 11, wherein the actuator is coupled to at least one of the first sidewall and the second sidewall of the container.

16. The container assembly of claim 11, wherein the container includes a pair of fork pockets positioned to receive fork arms of a front-loading refuse vehicle.

17. A refuse vehicle, comprising:
a chassis;
a cab positioned at a front end of the chassis; and
a container assembly including:
a container having a front wall, a rear wall positioned between the front wall and the cab, a first sidewall, and a second sidewall cooperatively defining an internal cavity, wherein the rear wall includes frame members extending at least one of vertically, horizontally, and diagonally along an interior surface of the rear wall; and
a collection arm assembly slidably coupled to the rear wall of the container such that the collection arm assembly is selectively extendable laterally outward from the container to facilitate engaging a refuse bin to deposit refuse into the internal cavity of the container.

18. The refuse vehicle of claim 17, further comprising a lift assembly including forks extending forward from the cab.

19. The refuse vehicle of claim 18, wherein the container includes a pair of fork pockets positioned to receive the forks of the lift assembly.

20. The refuse vehicle of claim 19, wherein the lift assembly is configured to lift the container assembly over the cab to empty the refuse within the internal cavity into a hopper of the refuse vehicle.
